(19) United States
(12) Patent Application Publication
(10) Pub. No.: US 2004/0200859 A1
(43) Pub. Date: Oct. 14, 2004

(54) Container for dispensing shampoo, gel and other similar products

(76) Inventors: Xavier Agramont Cruanyes, Sobrestany (ES); Gloria Barquet Torroja, Sobrestany (ES)

Correspondence Address: Ken J Pedersen, Pedersen & Company, PO Box 2666, Boise, ID, 83701-2666, US

(21) Appl. No.: 10/450,004

(22) PCT Filed: Sep. 17, 2002
(86) PCT No.: PCT/ES02/00440

(30) Foreign Application Priority Data
Oct. 4, 2001 (ES) U200102440

(51) Int. Cl. B67D 5/06

(52) U.S. Cl. 222/184; 222/560

(57) ABSTRACT

The invention relates to a container for dispensing shampoo, gel and other similar products. The inventive container solves the problem commonly posed by such containers when attempting to remove the product when only a small amount thereof remains, by turning the container upside down and leaving it resting on its lid, thereby making it unstable. Said container is characterised by the position of the lid opening which is disposed on the lower part of same. Moreover, the container comprises a pivoting lid which is disposed on the lower side wall of the container. The aforementioned lid comprises an upper area where it is joined to the container and a lower area which is provided with a flange that is used to stop the passage of the product contained in the container when in the closed position.

As indicated on the cover page, the present Utility Model application consists of a “CONTAINER FOR DISPENSING SHAMPOO, GEL AND OTHER SIMILAR PRODUCTS”, whose novel construction, shape, and design characteristics meet the goal for which it was specifically intended, doing so with maximal safety and effectiveness.

The invention relates specifically, but not exclusively, to containers for dispensing shampoo, and is applicable to containers that contain any liquid substance of a pasty nature.

The bottles of shampoo, creams, and similar products that currently exist on the market and that constitute the state of the art to which the present invention refers consist essentially of a chamber, customarily made of a plastic material having a certain degree of elasticity, such that pressure can be applied laterally to the container in order to extract the product contained therein for its application. Such containers include an outlet located in the upper portion of the chamber and means for opening and closing the said outlet.

The location of the outlet for the product contained within the chamber is the origin of the drawbacks that the present invention seeks to remedy in a particularly simple and effective way.

One of the drawbacks of the containers of this type is that they must be turned upside down for the application of the product contained within them. When only a small amount of the said product (such as shampoo) remains inside the container, the product emerges very slowly. In this case, it is customary to leave the container in the inverted position (with the cap at the lower portion) until the accumulation of the small amount of the remaining product can flow out. The inverted position of the container on any surface is unstable because of the presence of the cap, such that the container often falls over.

The invention proposes a new container for dispensing products of a pasty type (for example, a bottle of shampoo or a similar product), with which the above-mentioned drawbacks can be overcome in a simple, economical, and effective way.

The container for dispensing shampoo, gel, and other similar products that is the subject of the present invention consists essentially of a chamber provided with an outlet for the product (such as shampoo, cream, or similar products) and means for opening and closing the said outlet.

The particular characteristic of the container according to the present invention resides in the fact that the outlet for the product contained in the container is advantageously located in the lower portion of the chamber. In this way, the said product contained within the container flows out due to gravity, with no need to invert the chamber during its use.

In accordance with another characteristic of the invention, the means for opening and closing the outlet for the product contained within the chamber include a tilting cap that is provided on the lower side wall of the chamber. The tilting cap includes an upper region where it is joined to the chamber and a lower region provided with a protrusion that extends perpendicularly into the interior of the chamber, halting the passage of the product stored therein in the closed position.

The said tilting cap preferably includes a textured external surface, so as to facilitate its opening by the user.

According to the invention, the bottom of the chamber also includes a filler opening.

The characteristics and advantages of the novel container that is the subject of the present invention will be more clear from the detailed description of a preferred embodiment thereof. The said description is provided hereinbelow as a non-limitative example, with reference to the accompanying drawings, on which:

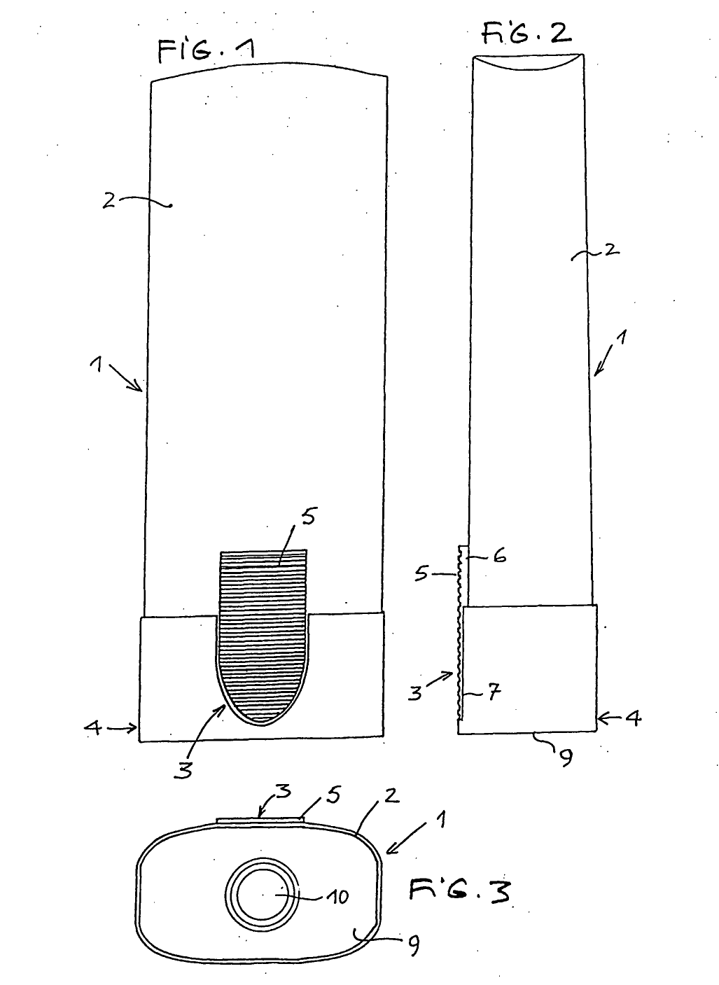

FIG. 1 is a front elevation view of an embodiment of a container for dispensing shampoo, gel, and other similar products in accordance with the present invention;

FIG. 2 is a lateral elevation view of the container for dispensing shampoo, gel, and other similar products, in the embodiment shown in FIG. 1;

FIG. 3 is a plan view of the container illustrated in the proceeding figures;

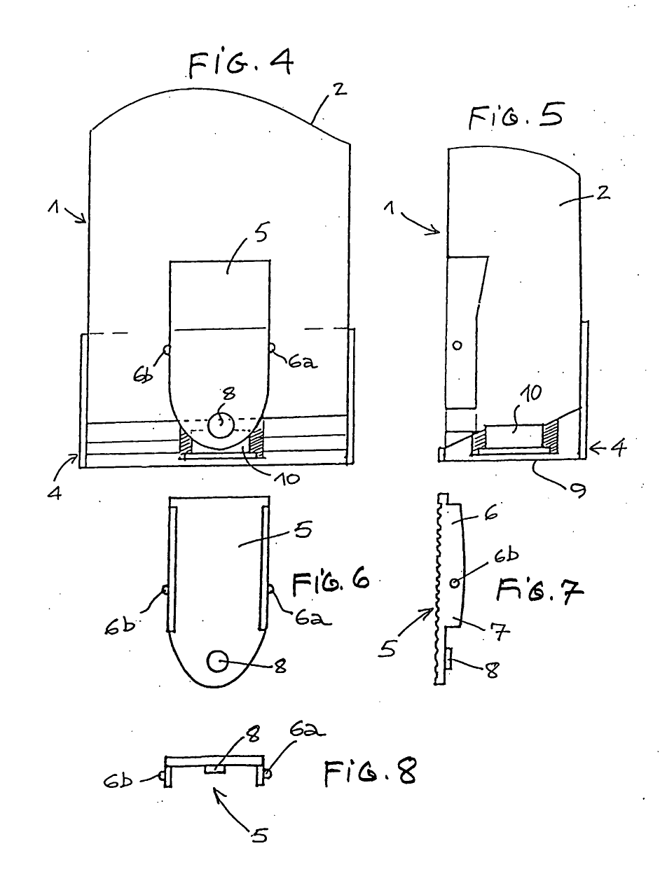

FIG. 4 is a partial, cross-sectional front elevation view of the container for dispensing shampoo, gel, and other similar products in accordance with the present invention;

FIG. 5 is a partial, cross-sectional lateral elevation view of the container according to the invention, and

FIGS. 6, 7, and 8 illustrate different views of the tilting cap of the container illustrated in the preceding figures.

The elements that appear in the attached figures are listed below:

[1] The container;

[2] The chamber;

[3] The outlet for the product contained [in the chamber];

[4] The lower portion of the chamber;

[5] The tilting cap;

[6] The upper region where the cap is attached;

[6a] [6b] The lateral protrusions of the cap;

[7] The lower region;

[8] The interior protrusion;

[9] The bottom of the chamber; and

[10] The filler opening.

A preferred, but not exclusive, embodiment of a container for dispensing shampoo, gel, and other similar products in accordance with the present invention will now be described, which embodiment is provided as a non-limitative example.

The container is question is designated overall by reference [1] in the figures on the drawings attached to the present descriptive memorandum. The said container [1] may customarily be made of a plastic or similar material, and may contain pasty or dense products such as shampoo, gel, soap, cream, and similar products.

The said container [1] consists of a chamber [2] that is provided with an outlet [3] for the product, such as shampoo, cream, or similar products, and means for opening and closing the said outlet.

As can be seen in the figures, the outlet [3] for the product contained in the container [1] is located in the lower portion [4] of the chamber [2], such that the product contained within the container [1] flows out due to gravity, with no need to invert the chamber [2].

The means for opening and closing the outlet for the product contained within the chamber [2] include a tilting cap [5] that is provided on the lower side wall of the chamber [2]. The tilting cap [5] includes an upper region [6] where it is joined to the chamber [2] by means of multiple lateral protrusions ([6a] [6b], and a lower region [7] provided with an interior protrusion [8] that extends perpendicularly into the interior of the chamber [2], halting the passage of the product stored within the chamber in the closed position illustrated in the figures,

As can be seen in FIGS. 1 and 2 on the drawings attached to the present descriptive memorandum, the tilting cap [5] includes a textured external surface, intended to facilitate the opening of the cap by the user.

As shown in FIG. 3, the bottom [9] of the chamber [2] includes a filler opening [10].

The materials of the elements that constitute the container described herein, as well as the shapes, dimensions, and other ancillary elements, may appropriately be replaced by others that are technically equivalent, provided that the essential nature of the present invention is not violated, nor the inventive concept of the invention, as defined in the following claims.

1. “CONTAINER FOR DISPENSING SHAMPOO, GEL AND OTHER SIMILAR PRODUCTS”, which container includes a chamber [2] provided with an outlet [3] for the product, and means for opening and closing the said outlet [3], characterized in that the said outlet [3] is located in the lower portion [4] of the chamber [2], such that the product contained within the chamber exits to the exterior due to gravity, with no need to invert the chamber [2] during its use.

2. “CONTAINER FOR DISPENSING SHAMPOO, GEL AND OTHER SIMILAR PRODUCTS” according to claim 1, characterized in that the means for opening and closing the said outlet [3], include a tilting cap [5] provided on the lower side wall of the chamber [2], which cap includes an upper region where it is joined to the chamber [2] and a lower region [7] provided with a protrusion [8] that extends perpendicularly into the interior of the chamber [2], halting the passage of the product stored within the chamber in the closed position.

3. “CONTAINER FOR DISPENSING SHAMPOO, GEL AND OTHER SIMILAR PRODUCTS” according to claim 2, characterized in that the said tilting cap [5] includes a textured external surface, so as to facilitate the opening of the cap by the user.

4. “CONTAINER FOR DISPENSING SHAMPOO, GEL AND OTHER SIMILAR PRODUCTS” according to claim 1, characterized in that the bottom [9] of the chamber [2] includes a filler opening [10].
